(19) United States
(12) Patent Application Publication
(10) Pub. No.: US 2007/0084776 A1
(43) Pub. Date: Apr. 19, 2007

(54) Water separation and filtration structure

(76) Inventor: Timothy M. Sasur, Newington, CT (US)

Correspondence Address: ALIX YALE & RISTAS LLP, 750 MAIN STREET, SUITE 1400, HARTFORD, CT, 06103, US

(21) Appl. No.: 11/540,041

(22) Filed: Sep. 29, 2006

Related U.S. Application Data
(60) Provisional application No. 60/722,485, filed on Sep. 30, 2005.

(51) Int. Cl. B01D 29/00

(52) U.S. Cl. 210/314; 210/335; 210/493.1; 210/505; 210/490

(57) ABSTRACT

A fuel conditioning structure filters fuel prior to the water separation mechanism. A coalescing media employs hydrophilic synthetic fibers that coalesce water even with the low surface tension present in fuels treated with additives/surfactants. The coalescing media employs a gradient structure of fine fibers/small voids to larger fibers/larger voids in the direction of fuel flow. This structure promotes water adhesion on the fine fibers and coalescence into large whole water droplets that are easily rejected by a water barrier. Pre-filtration extends the life of the coalescing media and water barrier by keeping these structures free of particulates, oxidized fuel and asphaltenes. This configuration helps prevent degradation in the ability of these layers to separate water over the life of the filter.

### CROSS REFERENCE TO RELATED APPLICATIONS

This application claims the benefit of U.S. Provisional Application No. 60/722,485, filed Sep. 30, 2005.

### FIELD OF THE DISCLOSURE

The present invention relates generally to fuel filters employed in connection with internal combustion engines and, more particularly, to filter assemblies that serve the dual purpose of removing water and particulates from fuel supplied to an internal combustion engine.

### BACKGROUND

Modern fuel injection systems demand effective fuel filtration and water separation. Water and particulates in diesel fuel are blended into suspension by various pumps, both before and after delivery to the fuel tank of a vehicle. Fuel filtration systems are configured to remove particulates and separate water from the fuel flow delivered to the internal combustion engine.

Filtration and water separation can be carried out by a single layer of filter media typically composed of cellulose, glass fibers, or synthetic polymer fibers blended with resins and additives. The glass fibers are naturally hydrophilic, attracting water and causing the water to coalesce from the emulsion into larger droplets. The cellulose fibers are the basic filtration material. The synthetic fibers are often provided to add strength. The media may be chemically treated to reject water, so coalesced water droplets remain behind as fuel passes through the media. Solid, hard particulates are trapped in pores of the media.

As fuel quality degrades due to oxidation or contamination, the surface tension of the fuel water interface lowers, causing a more stable fuel/water emulsion. Media coated with asphaltenes (removed from the fuel) and/or a film of sludgy oxidized fuel can weaken or eliminate the water separation function, so the water separating capability of filters typically degrades over time. Furthermore, fuel additives and surfactants can interfere with the ability of glass fibers to coalesce water from solution.

Typical Current Mechanism for Filtration and Water Separation:

Media is cellulose/glass fiber/synthetic fiber blend with resins and additives.

The glass fiber and resins provide the mechanism for water coalescing and separation on the surface of the media. Water “clings” to the glass fibers by means of direct interception. Water droplets collide and form larger droplets on the surface of the media. Once droplet size is large enough to overcome the inertial forces of the fluid flow and viscosity, the water falls to the bottom of the filter cartridge housing (the “can”) due to gravity and the relative density difference of the fuel and water. The cellulose and synthetic fibers create a pore structure and provide strength to the media. Resins formed of heavier molecular weight of oxidized fuel and asphaltenes coat the fibers while hard particulates become entrained in the pores as the fuel flows through the media.

Disadvantages of Current Mechanism:

Media is typically a single layer. The primary filtration is done on the surface of the media, with limited filtration through its depth. A large surface area is required to minimize the speed at which the fluid flows through the media (face velocity) and obtain adequate resident time for increased interception of the water and debris/particulates.

The presence of surfactants and additives normally found in fuel will disarm the silenol group on the glass fibers, disabling the hydrophilic properties of the glass fibers and allowing water to pass through the media.

Existing media may be less effective at separating water from the more stable fuel/water emulsion when the surface tension of the fuel is lowered by surfactants and additives.

Resins, adhesives and surface treatments required in glass fiber media reduce the open area of the media that would otherwise be available for filtration of particulates, oxidized fuel and/or asphaltene.

As dirty fuel coats the surface of the media, there are fewer sites remaining on the media surface for water separation, and the hydrophilic properties of the media will degrade. As a result of this process, used elements typically have a reduced ability to separate water from fuel when compared to a new element.

Current Multilayer Filter Media:

Multilayer melt blown/cellulose filter media are available and provide some improvements over the single layer media described above. Available multilayer media is configured to simultaneously filter, coalesce and separate water on the surface or in the initial depth of the media, requiring the water to fall out of the fuel against the direction of fuel flow. Also, available multilayer media are typically employed in arrangements that direct unfiltered fuel flow through the meltblown layers first and then the cellulose layers afterwards. This design exposes the more sensitive fine fibers of the melt blown layers to the unfiltered fuel. As the dirty, oxidized fuel and asphaltenes coat the unprotected melt blown material, filter performance will degrade while pressure across the filter media will increase before exhausting all the available life of the cellulose layers.

An object of embodiments of the present disclosure is to maximize the effective use of each layer of the filter media throughout the depth of the media, extending the life of the filter element, without sacrificing water separation performance.

Another object of embodiments of the present disclosure is to improve the efficiency of particle filtration and water separation within the spacial constraints of existing filter cartridge configurations.

A further object of the present disclosure is to provide a new and improved filter cartridge where obstruction of the filter media by material removed from the fuel flow does not impair the water separating capability of the cartridge.

### SUMMARY

Embodiments of a fuel conditioning structure filter fuel prior to the water separation mechanism. A coalescing media employs hydrophilic synthetic fibers that coalesce water even with the low surface tension present in fuels treated with additives/surfactants. The coalescing media employs a gradient structure of fine fibers/small voids to larger fibers/larger voids in the direction of fuel flow. This structure promotes water adhesion and coalescence into large whole water droplets that are easily rejected by a water barrier. Pre-filtration extends the life of the coalescing media and water barrier by keeping these structures free of particulates, oxidized fuel and asphaltenes. This configuration helps prevent degradation in the ability of these layers to separate water over the life of the filter.

### BRIEF DESCRIPTION OF THE DRAWINGS

FIG. 1 is a partial cut away view of a filter media according to aspects of the present disclosure;

FIG. 1A is an enlarged view of a portion of the filter media of FIG. 1;

FIG. 2 is a partial sectional view of an embodiment of a filter cartridge incorporating the filter media of FIG. 1; and

FIG. 3 is a partial sectional view of an alternative embodiment of a filter cartridge incorporating the media of FIG. 1.

### DETAILED DESCRIPTION OF A PREFERRED EMBODIMENT

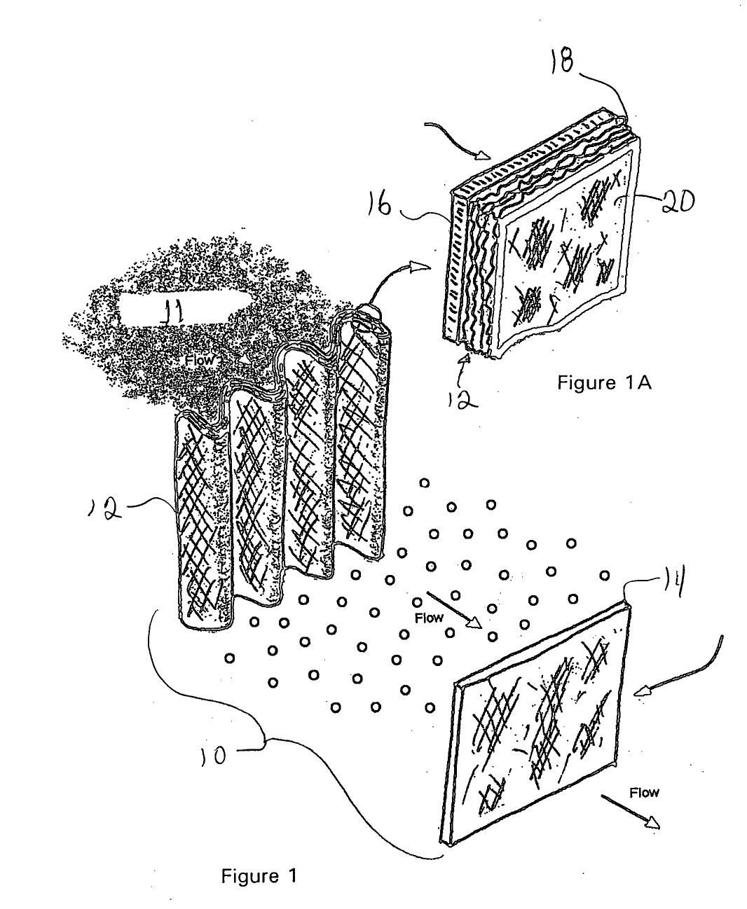

A preferred embodiment of the disclosed fuel conditioning structure carries out a filtration step before attempting to remove water. The fuel conditioning structure is illustrated in FIGS. 1 and 1A and is generally designated by the reference numeral 10. An exemplary embodiment of the fuel conditioning structure includes a filtration/coalescing media 12 and a water barrier 14. In the direction of fuel flow, a preferred embodiment of the filtration/coalescing media includes a filter media 16, a coalescing media 18 and a scrim layer 20. The first layer of the filtration/coalescing media 12 is dedicated to filtration and allows water to pass through. The most economical choice for the dedicated filtration layer 16 is a cellulose media, with minimal amounts of synthetic fibers, resins and treatments. The structure of such a cellulose layer can be accurately controlled to provide maximum open area for filtration. Cellulose fiber filter media are cost-efficient to manufacture and typically have consistent and uniform filtration properties. Lower resin content provides more open pores for filtration. Such a cellulose material will have the maximum open structure for a given surface area, maximizing the time that fuel is in contact with the filter media (resident time), increasing filtration performance. The cellulose layer 16 may be designed to remove particulates on the order of 2μ to 50μ depending on customer requirements. Employing a cellulose fiber media to remove particulates, e.g., for primary filtration, will increase the surface tension of the fuel/water interface downstream, allowing the water to coalesce and separate from the fuel stream more easily. One example of a cellulose layer has a weight of approximately 90 lbs per 3000 ft², a thickness of approximately 0.020″ to 0.040″ and air permeability in the range of 10 to 15 CFM/ft²@½ in water.

In the direction of fuel flow the disclosed filtration/coalescing media 12 includes a coalescing media 18 preferably composed of spunbonded or melt blown synthetic fibers that provide a porous network configured to coalesce water from the filtered fuel. This layer is formed of near continuous thermoplastic polymer fibers combined into self-bonded webs using melt-blowing or spun-bonding processes. These processes are well known and will not be described in detail here. This layer or layers of synthetic fibers will be referred to as “the coalescing media” and designated by reference numeral 18. Processes such as melt blowing or spin-bonding and wet laying of synthetic fibers, may be appropriate for manufacturing the coalescing, but the coalescing media 18 is not limited to materials manufactured by these methods.

While the primary function of the coalescing media 18 is to provide a hydrophilic structure on which water will collect, it also serves as a secondary filtration mechanism for the few small hard particles passing through the cellulose layer. A further aspect of the disclosed filter media relates to the synthetic fibers of the coalescing media 18 being arranged in phases or layers, with the density and/or fiber thickness of the synthetic fibers varying throughout its depth. The fiber diameters can vary from submicron sizes up to greater than 50μ. One strategy for adjusting the structure of the coalescing media is to vary the average diameter and/or density of the fibers. For a given density, use of smaller average diameter fibers in a phase or layer results in smaller voids between the fibers. A preferred embodiment varies the structure of the coalescing media from fine fibers/high density to coarse fibers/low density in the direction of fuel flow. This structure increases the probability of direct interception of water and/or debris particles in the fine fibers, while allowing water droplets forming on the hydrophilic fibers to coalesce into progressively larger whole water droplets on the coarse fibers as they move in the direction of fuel flow.

An aspect of the invention relates to structuring the synthetic fiber media such that the coalesced water droplets are allowed to grow larger while they remain within the fibrous network of the coalescing media. For example, the downstream layers or phases of the coalescing media will have the largest fiber diameter and the least density to entrain larger droplets. Similarly, the layers more upstream will have smaller fiber diameters and higher density to provide maximum surface area on the fibers to entrain the smallest water droplets and particulates. The gradient change in the arrangement of the fibers will establish a profile or pattern through the depth of the media. A relatively deep (thick) layer of media used with this structure will increase the resident time of the coalesced water droplets within the media, increasing the droplet size exiting the media. Greater thickness will also increase the proportion of free water (water dispersed, but not dissolved in the fuel) that is converted to whole water droplets and ultimately removed by the fuel conditioning structure 10. It should be noted that the whole water droplets in the disclosed arrangement are moving with the flow of fuel, not against it as in some of the prior art arrangements.

Preferred synthetic fibers are those that are naturally hydrophilic, such as nylon. Polyester is another suitable example, which can be treated to acquire hydrophilic properties. Biconstituent or bicomponent fibers may also be suitable. Biconstituent fibers are fibers formed from a mixture of two or more polymers extruded from the same spinneret. Bicomponent fibers are formed by extruding polymer sources from separate extruders. Bicomponent fibers have the advantage of a regular sectional configuration, such as a core/sheath configuration in which one material surrounds the other. The structure of a bicomponent fiber can be designed to take advantage of the properties of both materials, for example, the strength of the core material and the hydrophilic properties of the sheath material.

In a preferred embodiment, the cellulose material may serve as substrate or base layer upon which the synthetic fiber layer is constructed in a manner that controls its density and structure as discussed above. An additional thin/stiff layer of (“scrim”) may be added over the synthetic fiber layer to protect its structure during manufacturing and handling. Alternatively, the cellulose layer and one or more discrete layers of synthetic fibers may be bonded to form the filtration/coalescing media 12.

One example of a filtration/coalescing media 12 is the cellulose material disclosed above, in combination with two layers of melt blown nylon material having a basis weight of 40 g/M². The melt blown layer adjacent the cellulose layer has relatively fine fibers of between approximately 1μ and 15μ and an air permeability of approximately 84 CFM/ft²@½″ water. The downstream layer has fibers of between approximately 10μ and 25μ and an air permeability of approximately 187 CFM/ft₂@½″ water. A further possible layer might have fibers of between 20μ and 45μ and an air permeability of approximately 332 CFM/ft²@½″ in water with a basis weight of 40 g/M². It will be noted that, for the same basis weight of material, the finer fibers have a lower air permeability. This results from the smaller voids between the fibers and the relatively more densely packed fine fibers.

Experiments have shown that a filtration/coalescing media as described above followed by a water barrier removed approximately 98% of the free water in a fuel flow at a flow rate of approximately three times that of a prior art single layer media without failure.

After passing through the cellulose layer 16 and coalescing media 18, the flow includes clean filtered fuel and dispersed whole water droplets. Depending on the structure of the coalescing media 18, a whole water droplet can attain a size in the range from 200μ to 3000μ or greater in diameter. A final, porous, hydrophobic material is arranged to serve as a water barrier 14. This hydrophobic layer will be selected to have the largest suitable average pore size that will minimize the fluid velocity through it and still reject the incoming water droplets. Arranging the water barrier 14 after the cellulose layer 16 and coalescing media 18 will ensure that the water separating properties occur in the clean fuel, reducing or even eliminating degradation of the water separation function over time. The hydrophobic material may be treated cellulose or synthetic material, or naturally hydrophobic materials such as polyolefins such as polypropylene or fluoropolymers like Teflon.

According to a preferred arrangement, a space or gap is provided between the filtration/coalescing media 12 and the water barrier 14 as shown in FIG. 1. This space is preferably a radial gap arranged vertically so that gravity will aid the separation of water out of the fuel flow. The radial space is provided with one or more openings communicating with a reservoir for separated water at the bottom of the filter assembly.

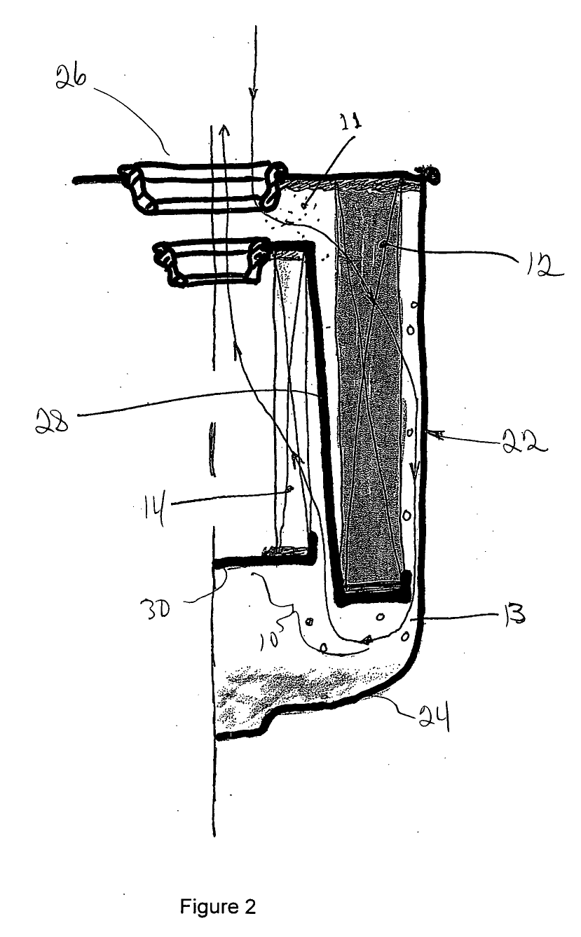

FIG. 2 illustrates a first preferred embodiment of a filter cartridge 22 employing the fuel conditioning structure 10 shown in FIGS. 1 and 1A. A cartridge housing 24 contains the fuel conditioning structure 10 and defines an axial opening 26 for fluid communication with the interior of the cartridge. The filter cartridge 22 is configured for reception in a base with co-axial conduits penetrating the axial opening 26 to define fluid delivery and retrieval pathways as shown in U.S. Pat. No. 6,187,188, the contents of which are hereby incorporated by reference. The interior of the filter cartridge 22 is configured to route dirty fuel first through the filtration/coalescing media 12 and then through the water barrier 14 before leaving the cartridge.

As shown in FIG. 2, one end of the filtration/coalescing media 12 is adhered to the upper end of the cartridge using a plastisol adhesive, or the like as is known in the art. The filtration/coalescing media 12 has a cylindrical pleated configuration to maximize the active surface area available for filtration. The lower end of the filtration/coalescing media 12 is enclosed by a concave end cap 28, which extends radially inwardly and upwardly to meet a fuel outlet conduit (not shown). The concave end cap 28 effectively separates the entering dirty fuel 11 from the filtered or clean fuel 13. In the cartridge configuration of FIG. 2, water droplets coalescing on the downstream side of the filtration/coalescing media 12 are carried along with the fuel flow toward the bottom, or sump of the filter cartridge. This movement and the change of direction at the bottom of the filter cartridge, along with gravity, assists the water droplets to accumulate at the bottom of the cartridge housing. The water barrier 14 is another pleated cylindrical element extending between the upper end of the concave end cap and its own end cap 30. Fuel must pass through the water barrier to enter the fuel outlet conduit and leave the cartridge. The water barrier 14 rejects water droplets that have not already been separated from the fuel.

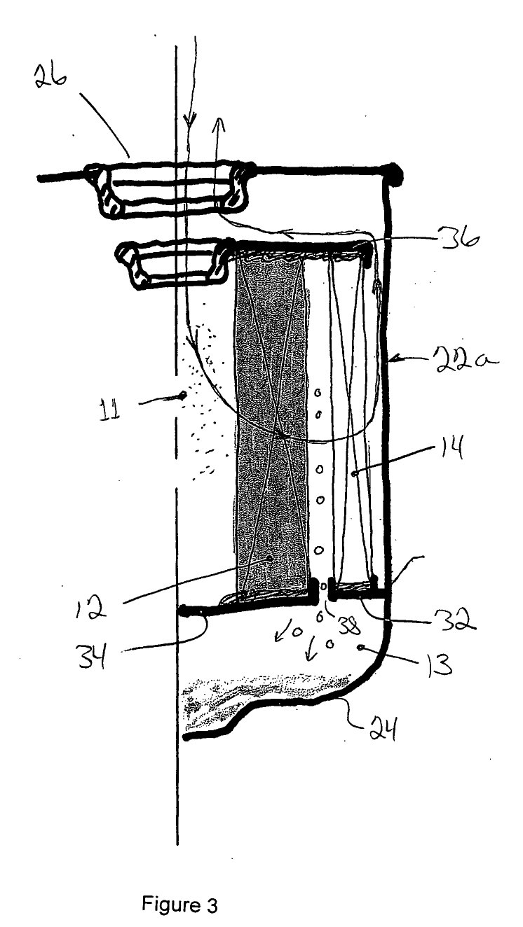

A second alternative embodiment of a filter cartridge incorporating the fuel conditioning structure 10 is illustrated in FIG. 3 and is designated by reference numeral 22a. In this configuration, the cartridge housing 24 defines an axial opening 26 and cooperates with a base and received coaxial fuel inlet and outlet conduits in the conventional way. In the configuration of FIG. 3 the central conduit (not shown) delivers dirty fuel to the center of the cartridge, where it is routed through the filtration/coalescing media 12. An end cap 34 separates the dirty fuel 11 from the clean fuel 13. In this configuration the water barrier 14 and the filtration/coalescing media 14 are again cylindrical pleated elements as is conventional in the art. The upper ends of the water barrier 14 and filtration/coalescing media are adhered to a common upper end cap 36 which extends radially inwardly to meet the fuel inlet conduit (not shown). Fuel flows radially outwardly first through the filtration/coalescing media, then through the water barrier 14 and upwardly to reach the fuel outlet conduit (not shown). A radial gap and axial openings allow water droplets to fall to the bottom of the cartridge and accumulate in the sump. Accumulated water is drained using a cock (not shown) located at the bottom of the cartridge housing 24 as is known in the art. End cap 32 includes a radial extension which meets the side wall of the cartridge to prevent fuel containing water droplets from mixing with fuel that has passed through the water barrier 14.

It is possible to reverse the relative positions of the filtration/coalescing media 12 and water barrier 14 and reverse the flow of fuel in the cartridge of FIG. 3. However, this would require a seal of high integrity where the end cap 32 meets the side wall of the cartridge housing to prevent dirty fuel from mixing with clean fuel. Since the particulates may be as small as 5μ or less, the required tight seal may be difficult to achieve, making such an arrangement impractical.

The disclosed filtration/coalescing media 12 may also be compatible with a two stage filter cartridge similar to that disclosed in U.S. Pat. No. 4,976,852.

While a preferred embodiment of the foregoing filter media has been set forth for purposes of illustration, the foregoing description should not be deemed a limitation. Accordingly, various modifications, adaptations and alternatives may occur to one skilled in the art and such adaptations and alternatives are intended to be encompassed by the appended claims.

What is claimed is:

1. A fuel conditioning structure for removing particulates and separating water
entrained in a fuel flow, said fuel conditioning structure comprising, in the direction of fuel flow:
a filtration media comprising cellulose fibers;
a coalescing media adjacent said filtration media, said coalescing media comprising hydrophilic synthetic fibers having average diameters that increase in the direction of fuel flow; and
a water barrier spaced apart from said coalescing media in the direction of fuel flow,
wherein said fuel conditioning structure routes fuel through said filtration media, said coalescing media and said water barrier.

2. The fuel conditioning structure of claim 1, wherein said coalescing media comprises a plurality of layers of hydrophilic synthetic fibers, each layer having an average fiber diameter, said layers arranged with the layer having the smallest average fiber diameter upstream from the layer having the largest average fiber diameter.

3. The fuel conditioning structure of claim 1, wherein said coalescing media comprises a plurality of layers of hydrophilic synthetic fibers, each layer having an air permeability, said layers arranged with the layer having the lowest air permeability upstream from the layer having the highest air permeability.

4. The fuel conditioning structure of claim 1, wherein said hydrophilic synthetic fibers comprise nylon fibers that have fiber diameters that increase from approximately 1μ to 15μ to approximately 20μ to 40μ in the direction of fuel flow.

5. The fuel conditioning structure of claim 1, wherein said hydrophilic synthetic fibers comprise a polymer fiber.

6. The fuel conditioning structure of claim 1, wherein said hydrophilic synthetic fibers are in the form of a melt blown or spunbonded web.

7. The fuel conditioning structure of claim 1, wherein said water barrier is selected from the group consisting of: a cellulose fiber media treated to reject water, and a porous media formed from a hydrophobic material.

8. The fuel conditioning structure of claim 7, wherein said hydrophobic material is an olefin or a fluoropolymer.

9. A fuel filter cartridge incorporating a fuel conditioning structure, said fuel filter cartridge comprising:
a housing defining an axial opening for fluid communication with an interior of said housing;
structures defining a fluid flow path within said housing extending from an inlet to an outlet;
said fuel conditioning structure comprising and in a direction of fuel flow:
a filtration media comprising cellulose fibers;
a coalescing media adjacent said filtration media, said coalescing media comprising hydrophilic synthetic fibers with average diameters that increase in the direction of fuel flow; and
a water barrier,
wherein said filtration media, coalescing media and water barrier are connected to said structures across said fluid flow path such that said fuel must flow through each of said filtration media, said coalescing media and said water barrier in sequence before exiting said filter cartridge.

10. The fuel filter cartridge of claim 9, wherein said filtration media and said coalescing media are in substantial face to face contact.

11. The fuel filter cartridge of claim 9, wherein said coalescing media defines voids having an average size that increases in the direction of fuel flow.

12. The fuel filter cartridge of claim 9, wherein said filtration media and said coalescing media are combined in a first cylindrical pleated element, said water barrier is a second cylindrical pleated element coaxial with, radially spaced from and substantially surrounded by said first cylindrical element.

13. The fuel filter cartridge of claim 12, wherein said fuel flows radially outwardly and downwardly through said first cylindrical pleated element and radially inwardly and upwardly through said second pleated element.

14. The fuel conditioning structure of claim 9, wherein said hydrophilic synthetic fibers comprise nylon fibers that have fiber diameters that increase from approximately 1μ to 15μ to approximately 20μ to 40μ in the direction of fuel flow.

15. The fuel conditioning structure of claim 9, wherein said hydrophilic synthetic fibers comprise a polymer fiber.

16. The fuel conditioning structure of claim 9, wherein said hydrophilic synthetic fibers are in the form of a melt blown or spunbonded web.

17. The fuel conditioning structure of claim 9, wherein said water barrier is selected from the group consisting of: a cellulose fiber media treated to reject water, and a porous media formed from a hydrophobic material.

18. The fuel conditioning structure of claim 17, wherein said hydrophobic material is an olefin or a fluoropolymer.
